(19) United States
(12) Patent Application Publication
(10) Pub. No.: US 2025/0348563 A1
(43) Pub. Date: Nov. 13, 2025

(54) Systems and Methods for Preventing Unauthorized Access to Computing Systems

(71) Applicant: The PNC Financial Services Group, Inc., Pittsburgh, PA (US)

(72) Inventor: Sean SABALL, Pittsburgh, PA (US)

(21) Appl. No.: 18/958,146

(22) Filed: Nov. 25, 2024

Related U.S. Application Data
(60) Provisional application No. 63/643,491, filed on May 7, 2024.

(51) Int. Cl. G06F 21/31

(52) U.S. Cl. CPC G06F 21/31

(57) ABSTRACT

Systems and methods are provided for preventing unauthorized access to a computing system. An identity access protocol repository is accessed to retrieve an access protocol associated with a particular resource. Information associated with a first identity is received from the particular resource based on access protocol associated with the particular resource. A determination is made regarding whether the first identity is a privileged identity based on the received information associated with the first identity, and the first identity is added to a secure identity repository when the first identity is determined to be a privileged identity.

### CROSS-REFERENCE TO RELATED APPLICATIONS

The present application claims priority to U.S. Provisional Application No. 63/643,491, filed May 7, 2024, which is incorporated herein by reference in its entirety.

### FIELD

This disclosure is related generally to data security and more particularly to monitoring identity creation in a networked environment.

### BACKGROUND

As computing power continues to increase, organizations are able to take advantage of more and more tools for improving their performance. Those tools can provide wide arrays of functionalities from databases to store data to computing engines (including artificial intelligence-optimized multiprocessor engines) for performing analysis and critical tasks. Human users, in some instances both inside and outside of the organization, may be able to utilize these tools. In certain examples, one computing resource is able to utilize another computing resource (e.g., a web application (app) is able to interact with a database to access data associated with a customer for display).

Computing networks are typically utilized to interconnect the computing tools that an organization selects to include in its systems. Because of the sensitivity of access to an organization's data and other resources, security protocols are implemented to prevent unauthorized access. Users, and often networked resources themselves, are assigned identities and corresponding credentials that regulate their permissions for accessing resources. An identity is verified (e.g., by a username/password challenge) before access to a requested resource is granted.

### SUMMARY

Systems and methods are provided for preventing unauthorized access to a computing system. An identity access protocol repository is accessed to retrieve an access protocol associated with a particular resource. Information associated with a first identity is received from the particular resource based on access protocol associated with the particular resource. A determination is made regarding whether the first identity is a privileged identity based on the received information associated with the first identity, and the first identity is added to a secure identity repository when the first identity is determined to be a privileged identity.

As another example, a system for preventing unauthorized access to a computing system includes an identity access protocol repository configured to contain access protocols associated with a plurality of resources. An identity access engine is configured to access the identity access protocol repository to retrieve an access protocol associated with a particular resource and to receive information associated with a first identity associated with the particular resource from the particular resource based on the access protocol. An entity data store is configured to retain data for use by the identity access engine to determine whether the first identity from the particular resource is a privileged identity, and a secure identity repository for storing data associated with the first identity when the first identity is determined to be a privileged identity.

As a further example, a system for preventing unauthorized access to a computing system includes means for accessing an identity access protocol repository to retrieve an access protocol associated with a particular resource and means for receiving information associated with a first identity from the particular resource based on access protocol associated with the particular resource. The system further includes means for determining whether the first identity is a privileged identity based on the received information associated with the first identity and means for adding the first identity to a secure identity repository when the first identity is determined to be a privileged identity.

### DESCRIPTION OF DRAWINGS

FIG. 1 is a diagram depicting a centralized identity access for preventing unauthorized access to a computing system.

FIG. 2 is a diagram depicting a centralized identity access engine interacting with a plurality of resources and a secure identity repository.

FIG. 3 is a diagram depicting example details of a system for analyzing identities and preventing unauthorized access to a computing system.

FIG. 4 is a diagram depicting an example identity access engine network topology.

FIG. 5 is a diagram depicting example secure identity repository data records for loading into a secure identity repository.

FIGS. 6-8 provide example reporting from a centralized identity aggregation engine.

FIG. 9 is a diagram depicting an example process for retrieving an access protocol associated with a particular resource.

FIG. 10 is a diagram depicting an example process for retrieving information associated with a first identity from the particular resource.

FIG. 11 is a diagram depicting an example process for determining whether a first identity is a privileged identity.

FIG. 12 is a diagram depicting an example process for adding the first identity to a secure identity repository.

FIG. 13 is a flow diagram depicting a method of preventing unauthorized access to a computing system.

FIGS. 14A, 14B, and 14C depict example systems for implementing the approaches described herein for implementing centralized identity access engine.

### DETAILED DESCRIPTION

As noted above, because of the sensitivity of access to an organization's data and other resources, identity-based security protocols are implemented to prevent unauthorized access. An identity is verified, by a username/password challenge or other credential check, before access to a requested resource is granted. Improper identities, and identities with an improper scope can result in security vulnerabilities. For example, if an identity is assigned to a malicious entity (e.g., a malicious user, a malicious software entity), that identity can be used for improper purposes, such as unauthorized access to data or damaging/disabling systems to which access has been granted. As another example, proper identities could be misappropriated to facilitate malicious behavior. For example, a compromised password could enable a user or entity to gain unauthorized access to data or systems.

To prevent unauthorized access, an organization's security governance function may seek to monitor the creation and status of identities. Monitoring creation of new identities can allow action to be taken to mitigate malicious behavior. Once detected, an improper identity can be disabled or otherwise to prevent access. In some instances, identities may be provided with differing levels of access. For example, identities may be assigned a security level that permits or limits which information they are able to access (e.g., read access for data that meets X criteria) and which actions they are permitted to execute (e.g., read/write access for data having Y criteria, read/write access for all data, permission to execute certain stored procedures). Monitoring of identities and their associated security level can prevent unauthorized accesses, such as when an identity is granted privileged access beyond what is appropriate.

An organization may further wish to monitor the status of identities, particularly identities having privileged access to systems, to ensure adherence to certain security policies. For example, a security policy may require privileged identities to change their passwords periodically, such as every 30 days or utilize two-factor authentication (2FA) for access. Such policies may differ from those applicable to identities having lesser access (e.g., where typical accounts have a 90 day password change policy). Knowledge of which identities those policies are applicable to (i.e., which identities have privileged access) can enable enforcement of such policies.

Identities are not limited to human users. In many computing system, one computing resource interacts with another computing resource in an autonomous or semi-autonomous fashion using identities (e.g., username/password credentials). For example, an executing software process may open a connection to a database based on credentials associated with the software process to perform read operations, write operations, or other operations. In many instances, the security level associated with the service's identity is high, such that the identity is considered privileged, where proper security protocols should be put in place. Thus, systems and methods herein may monitor, analyze, and take action regarding identities of not only humans, but also hardware, software, and other entities.

In complex computing systems, monitoring identities, their levels of access, and adherence to policy can become complex. While individual hardware and software components may have mechanisms for querying identities, those protocols for accessing identity information may differ significantly from one another. It may be desirable for an organization to employ a centralized system for accessing identity information from a plurality of disparate hardware or software resources of a system; monitoring those identities based on factors such as their security level or mere existence; enforcing security protocols (password change protocols); and taking appropriate remedial action (e.g., issuing an alert for administrator action, disabling access by an identity, reducing a security level of an identity) when necessary.

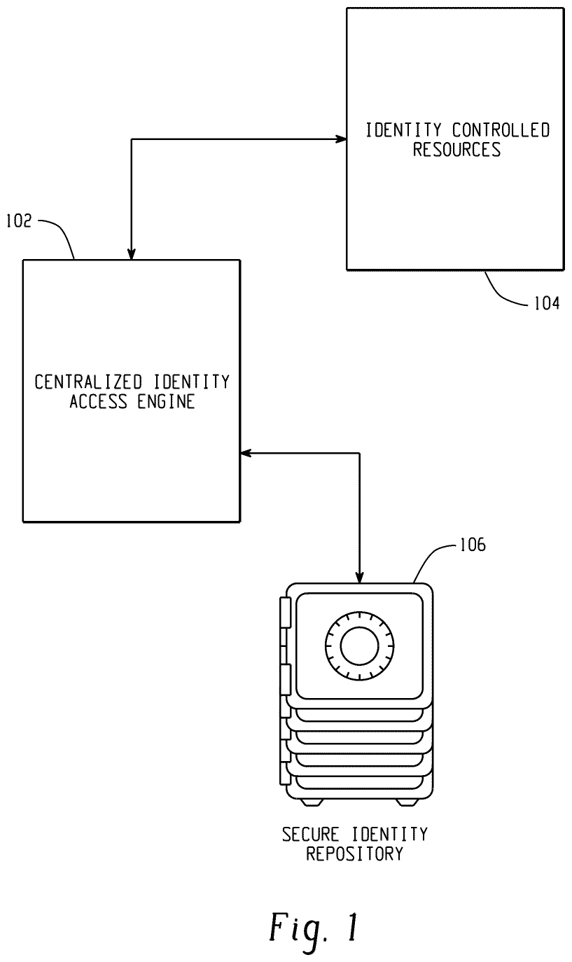

FIG. 1 is a diagram depicting a centralized identity access for preventing unauthorized access to a computing system. A centralized identity access engine 102 communicates with a plurality of identity controlled resources 104. Those resources 104 may take a variety of forms in both hardware and software. The resources may include a database containing records, some or all of which are of sensitive nature. In certain systems and identity may be granted access to access certain of those records at one security level, while that same or a different identity at a different security level may be granted access to all of the data records. Certain identities may be at a security level that can see none of the data records therein. Security levels may also correspond with actions permitted on the data records, where one security level may have read only access, where a higher security level may have read/write access to certain or all data records. As another example, certain security levels may have administrator-type access where they are permitted to add, edit, or drop tables of the database.

In another example, the identity controlled resource is a service (e.g., an online storefront service). An identity may be associated with a security level and a role. For example, an identity having a particular security level and a merchant role may be able to add and edit items to the store for purchase. An identity having a lower security level and a merchant role may be able to edit but not add items to the store. A different identity having a particular security level and a customer role may be able to view items in the store and purchase items in the store. A further identity having a particular security level and a logistics role may be able to view orders in the store so as to facilitate packaging and shipment.

In a further example, an identity controlled resource may be a hardware resource such as a firewall. There, an identity having a first security level may be permitted to traverse the firewall to access resources behind the firewall, while identities with lesser security levels may not be permitted to traverse the firewall.

The number and type of identity controlled resources 104 may vary significantly by system. Some systems may include a small number of resources 104 (e.g., one, two, less than ten), while other more complex entities may have many identity controlled resources (e.g., 20, 50, 100, 1000, or more). Those resources 104 may be hardware, software, or a combination of both. Example resources include a data store, a database, the secure identity repository, a particular record in a data store, a server, a service operating on a server, an operating system, an enterprise manager, an active directory, a network automation engine, network attached storage, an identity management store, a mainframe, an application, a computer, a phone, and a mobile communication device.

The centralized identity access engine 102 is configured to interact with the identity controlled resources 104 to access information associated with identities that have access privileges associated with those resources 104. For example, for a database, that information may include usernames, email addresses, and security levels for all identities that have accounts registered for accessing the database. The engine 102 then processes that information received from the resources 104, such as with the intention of identifying anomalous accounts that should have their security level rescinded or changed; or for identifying accounts that should be monitored for compliance with security protocols. For example, identities that have a particular security level or higher for a particular resource may be deemed a privileged identity. Such privileged identities may be identified to a secure identity repository 106, which facilitates safe storage of information associated with those identities and enforcement of privileged identity security protocols (e.g., frequent password changes, 2FA).

In certain embodiments, what qualifies as a privileged identity may differ from resource to resource. For example, for one data store, an identity that has write access to add or change records in the data store may be deemed a privileged identity, while for another data store, only identities having administrator-type access to augment the structure of the data store (e.g., add tables, drop tables, delete files) may be deemed a privileged identity. As described in further detail below, a centralized identity access engine 102 may have mechanisms for analyzing information associated with identities received from identity controlled resources 104 to determine whether those identities should be deemed privileged identities.

The engine 102 may utilize a variety of mechanisms for accessing information associated with resources from the identity controlled resources 104. And in some examples, different mechanisms may be used for different ones of the resources 104. For example, one resource may be configured to provide information associated with identities to the engine 102 in response to a request, in a pull-type arrangement. In another example, a resource may be configured to provide information associated with identities to the engine 102 periodically or on occurrence of an event (e.g., an account creation, a security level promotion or demotion for an identity), in a push-type arrangement. In another example, a resource may have an application programming interface (API), whereby a predefined protocol is provided for the engine 102 to request or access information associated with identities from the resource. In some examples, information about all identities is provided by a resource to the engine 102 on each access. In other examples, only new or changed information associated with identities is provided to the engine on each access. Mechanisms for the engine to receive information associated with identities from different resources 104 are described further below.

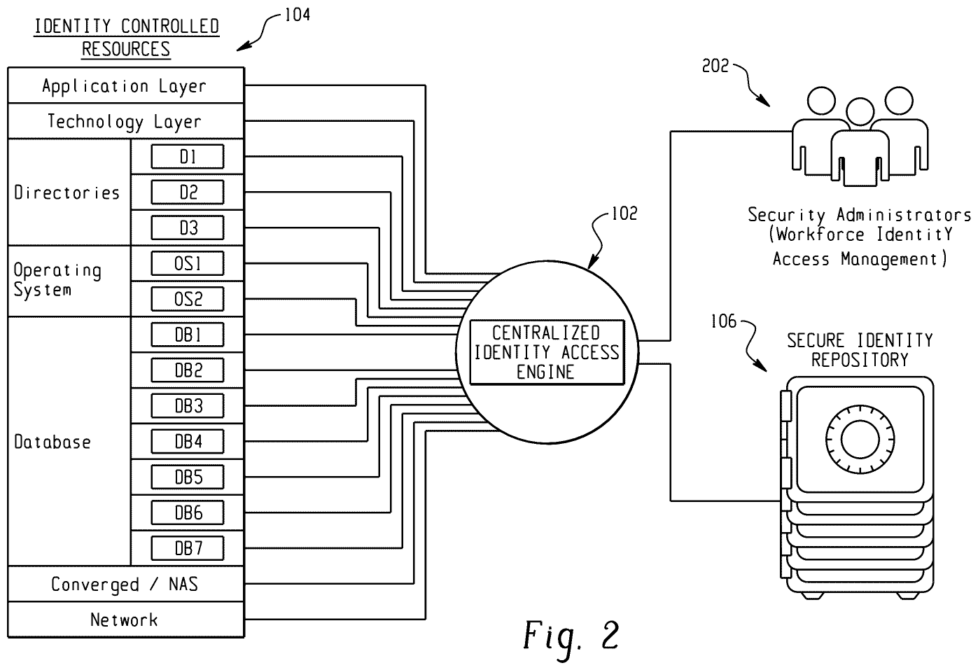

As noted above, a centralized access engine may interact with a number of disparate identity controlled resources. FIG. 2 is a diagram depicting a centralized identity access engine interacting with a plurality of resources and a secure identity repository. The centralized identity access engine 102 is configured to interact with a set of identity controlled resources 104. Certain of those resources are application layer resources. Certain of those resources are technology layer resources. In the technology layer, the engine 102 interacts with three directories (e.g., active directories by Microsoft, unified directories by Oracle) D1, D2, D3. The engine 102 interacts with two operating systems (e.g., a Unix operating system, a Microsoft operating system). The engine 102 interacts with a number of databases (e.g., databases by Oracle, Microsoft, Teradata). The engine further interacts with converged/Network Attached Storage and other network resources. In examples, the engine 102 interacts with additional or other resources, including cloud environments and resources associated with cloud environments (e.g., Azure, AWS, GCP). The centralized identity access engine 102 interacts with those identity controlled resources 104 to receive information associated with identities (e.g., via push, pull, API access), where the mechanism for accessing that information may differ for different resources 104.

In embodiments, the centralized identity access engine 102 analyzes the information associated with identities received from the resources 104 to take action. In some instances, the engine 102 may take action when it detects anomalous behavior, such as creation or promotion of security level of a suspicious identity (e.g., issuing an alert to an administrator 202 to take action, disabling or demoting the security level of that identity). Other actions may include adding identities (or modifying records associated with previously added identities) to a secure identity repository for enforcement of security protocols. In some embodiments, all identities are added to the repository 106. In other examples, identities that meet criteria that indicate that those accounts are privileged are added to the repository 106. In embodiments, security administrators 202 provide a variety of functions, including setting the criteria for identifying which identities are deemed privileged, identifying the protocols by which the engine 102 can request or otherwise receive information associated with identities from the resources 104, and criteria for indicating when an identity is deemed anomalous for taking action or issuing an alert.

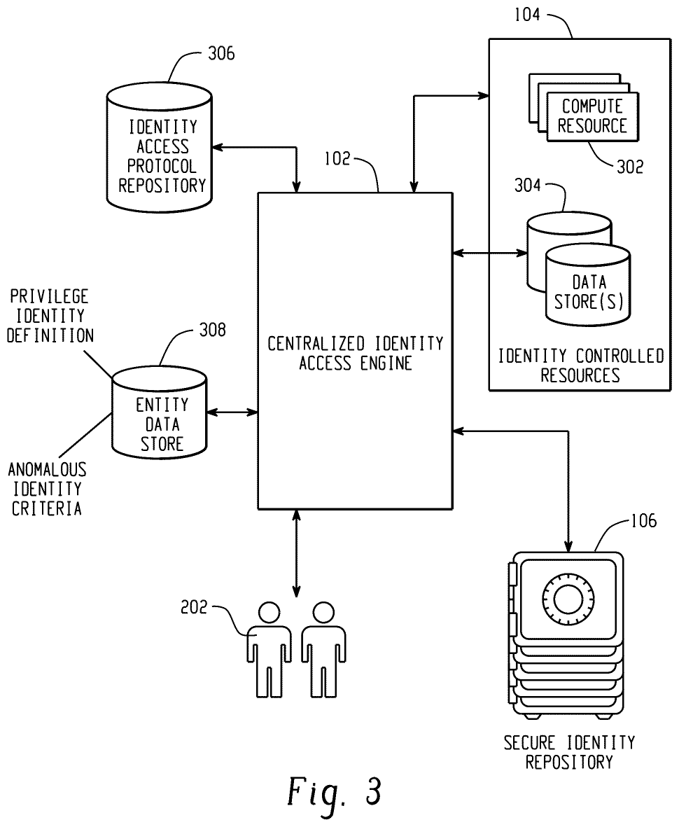

FIG. 3 is a diagram depicting example details of a system for analyzing identities and preventing unauthorized access to a computing system. A centralized identity access engine 102 interacts with identity controlled resources 104, such as compute resources 302 (e.g., software, hardware) and data stores 304 to access information associated with identities that are permitted to access those resources 104. The protocols for communicating with those identity controlled resources 104 to access the identity information is stored in an identity access protocol repository 306. In an example, for each of the identity controlled resource 104, the identity access protocol repository 306 contains a record indicating how the centralized identity access engine 102 can access identity information from that resource (e.g., that information is received via a pull operation initiated by the engine 102, via a push operation initiated by the one of the resources 104, via provided software instructions for communicating with one of the resources via an API).

The centralized identity access engine 102 is configured to access the identity access protocol repository 306 to retrieve an identity access protocol associated with a particular resource (e.g., 302, 304). The engine 102 then receives information associated with one or more identities from the particular resource based on the access protocol associated with that particular resource received from the protocol repository 306. In embodiments, the engine 102 is configured to interact with the resources 104 (e.g., pull-access resources, API-access resources) periodically (e.g., hourly, daily, weekly) to access identity information. Other resources, such as the push-access resources, may be configured to push identity information based on a variety of criteria, such as on identity creation, on a change to an identity security level, or periodically.

The engine 102 may be further configured to analyze the information associated with identities received via the protocols. For example, the engine 102 may analyze the identities to see whether any are identities are indicative of anomalous behavior or access. In an embodiment, the engine 102 may compare received identity information to anomalous identity criteria received from an entity data store 308 that indicates characteristics that indicate that anomalous behavior may be occurring. In certain embodiments, the anomalous identity criteria may differ for different ones of the identity controlled resources 104. New identities and identities having their security level increased (e.g., to the point of becoming privileged identities) may be especially scrutinized. A variety of criteria may be used for anomalous behavior analysis. For example, more than a threshold number of identities being created or having their security level raised within a predetermined period of time may trigger an alert or identity access halt condition. An identity being associated with a certain location or organization (e.g., certain countries, certain organizations, certain companies, certain governmental bodies) may indicate possible anomalous behavior.

In one example, an artificial intelligence or machine learning model may be used to detect anomalous behavior. In one instance, a model is trained by providing it with information associated with a large number (e.g., thousands, millions, billions) of identities and indications of whether those identities were associated with anomalous behavior. Based on those examples, the model is trained to indicate whether or a likelihood that a current identity should be flagged as anomalous or have its access disabled or reduced. The received information associated with the current identity is provided to that model (e.g., from 308) trained using a plurality of anomalous identities and a plurality of permissible identities, and a recommendation that action be taken or not is received from the model.

The centralized identity access engine 102 may also analyze the identity data to identify identities that should be classified as privileged accounts. In examples, privileged identity definitions are retrieved from the entity data store 308, where in some instances the definition of a privileged identity differ from one resource of 104 to the next. The engine is configured to determine wither identities are privileged identities based on the information associated with those identities received from the resources 104. When an identity is determined to be a privileged identity, that identity is added to the secure identity repository 106 for secure storage and to ensure that privileged identity security protocols are applied to that identity. The engine 102 may provide other analysis as well, such as indicating deletion or security level reductions for identities. For example, the engine 102 may determine whether an identity that is present in the secure identity repository 106 was not returned by its associated resources 104, indicating that identity has been deleted or otherwise changed. In some instances, such an occurrence may be indicative of anomalous behavior.

The engine may further provide reporting functionality based on identity information that it receives from the resources 104 and analysis on that identity information. For example, the engine 102 may report on the number of accounts created for individual resources and all resources over a period of time. The engine 102 may further report on numbers of security level changes on a resource or enterprise basis. The engine 102 may also report on the number of times that action was taken based on detection of anomalous or likely anomalous identities within individual resources or across the enterprise.

Human operators 202, such as security administrators, may interact with the engine 102. Such interactions may be for configuration purposes, such as for entering new or revised protocols into the repository 306 to facilitate interactions with a new or updated resource within the pool of identity controlled resources 304. The operators 202 may further interact with the engine to insert or revise data in the entity data store 308, such as privilege identity definitions for resources and anomalous identity criteria. The engine 102 may further be configured to provide reports and information about identities to the operators 202, where in some instances that information is only provided if the operators 202 have sufficient security credentials.

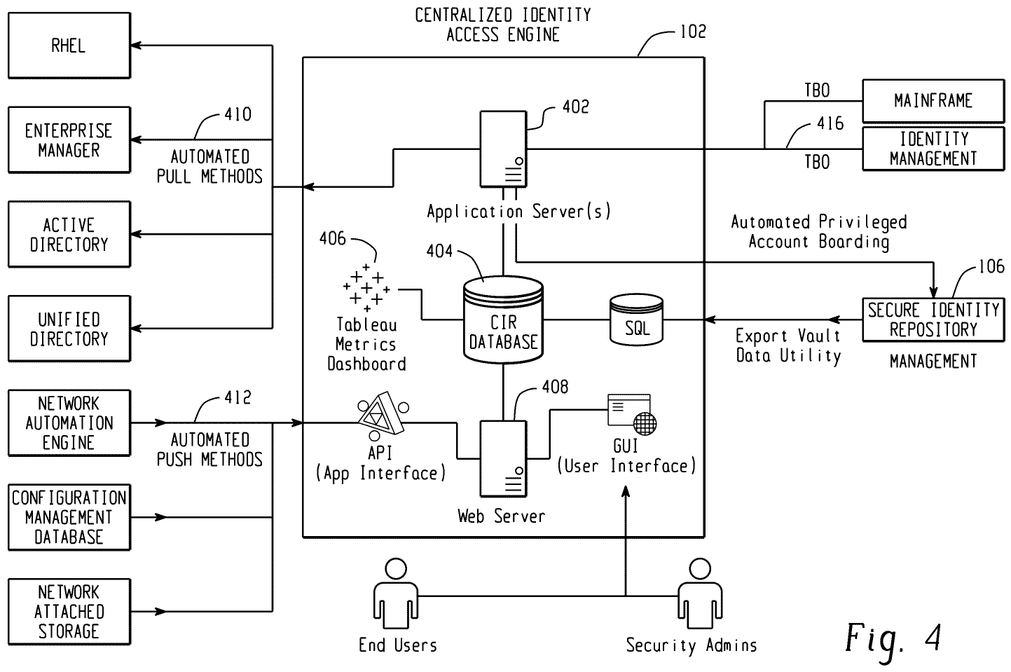

A centralized identity access engine may operate within a wide variety of computing environments. FIG. 4 is a diagram depicting an example identity access engine network topology. A centralized identity access engine 102 is implemented by an application server executing software thereon for implementing the engine 102. The engine 102 includes one or more data stores 404 for storing data relevant to the engine 102, such as the identity access protocol repository 306 data and entity data store 308 data discussed with reference to FIG. 3. The engine 102 includes a metrics dashboard 406 for generating reporting regarding identity information retrieved and analyzed by the engine 102. The engine 102 further includes a web server 408 that interacts with GUIs to facilitate interaction with operators, such as end users and security admins.

The centralized identity access engine 102 interacts with several other entities via a wired or wireless network. As discussed above, the engine interacts with a secure identity repository 106 for storage of information associated with all or a subset of identities, such as privileged identities. As described above, the engine 102 further interacts with resources to access information about identities having access thereto. In the example of FIG. 4, the engine 102 has access to identity information from an RHEL (Linux) operating system, an enterprise manager, and directory stores via pull operations at 410. Identity information is pushed to an API of the engine 102 at 412 by a network automation engine, a configuration management database, and a network attached storage unit. Other entities, including a mainframe and identity management unit at 416, include their own APIs via which the engine 102 may interact to request and then receive entity data.

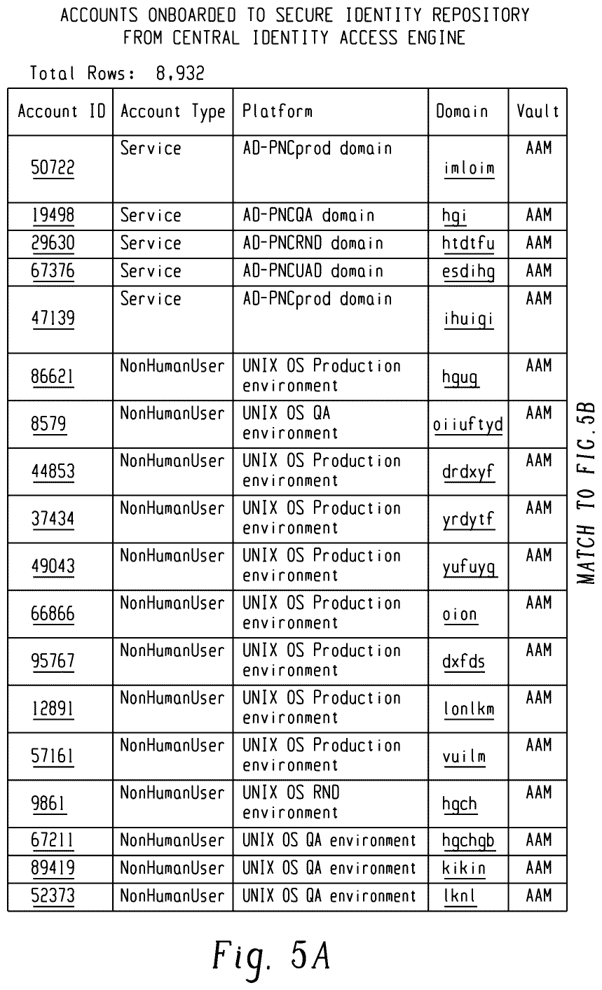

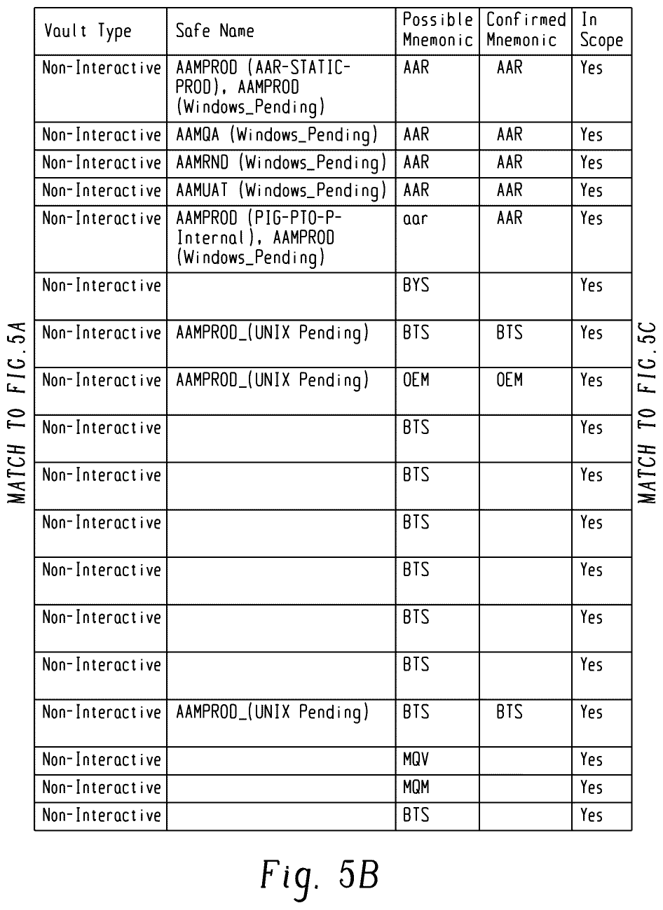

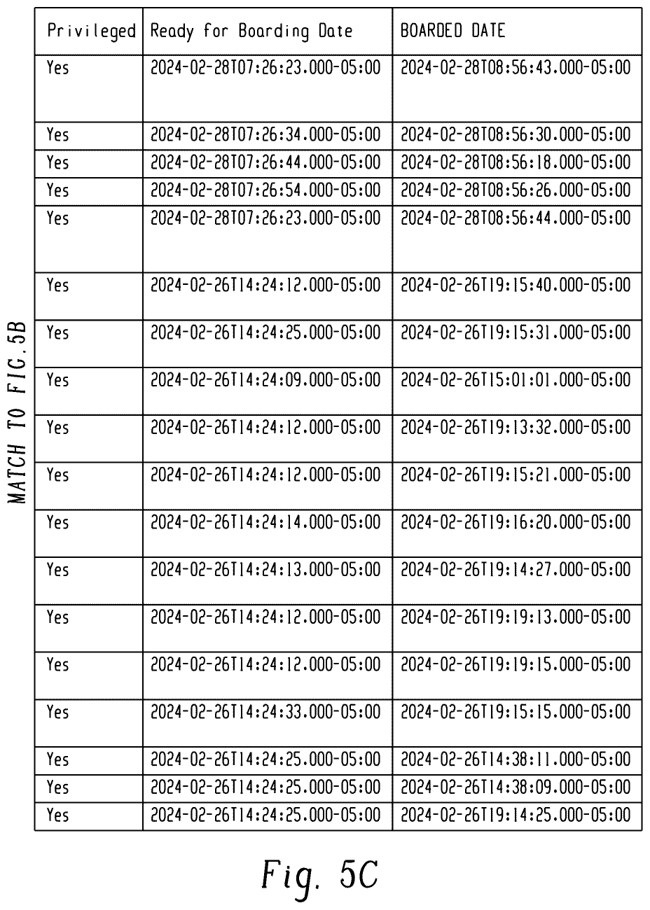

As noted above, records associated with accounts, such as privileged accounts, may be added to a secure identity repository, to track those identities and ensure that security protocols are applied to those identities. FIG. 5 is a diagram depicting example secure identity repository data records for loading into a secure identity repository. An example record includes an Account ID. An Account Type indicates whether the associated identity is a service, a human, or other type of non-human user. A Platform field indicates the platform associated with the identity, and a Domain field indicates the accessing identity's domain. The next three fields indicate details of to which of the particular secure identity repository to which that identity's information has been or will be loaded. Mnemonic fields indicate the particular resource with which the identity is associated. The In Scope and Privileged fields confirm that the identity is an identity having privileged access that should be loaded into the indicated secure identity repository. The final fields indicate the that identity is ready for loading into the repository and tracking when that loading actually occurs.

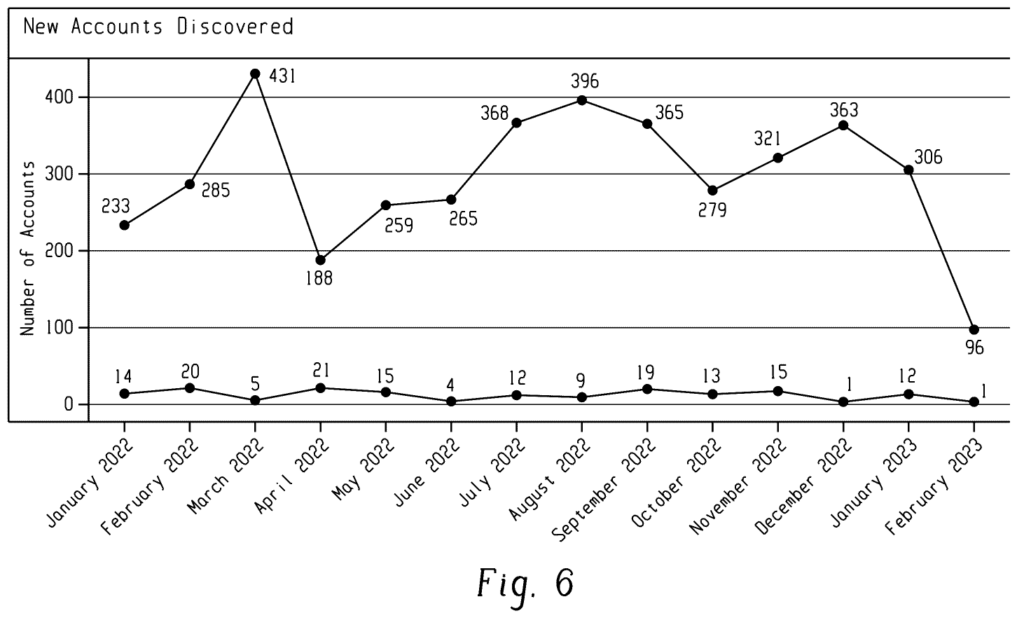

As noted above, a centralized identity aggregation engine may provide a wide variety of analysis and reporting on identity information. FIGS. 6-8 provide example reporting from a centralized identity aggregation engine. FIG. 6 provides an example report identifying a number of new accounts for identities discovered throughout an enterprise during a preceding week. A top line indicates all identities discovered during the week, while a lower line indicates a number of accounts identified as having a privileged level of access. In some instances where a number of identities discovered during a week is higher or lower than the norm, a system may be configured to issue an alert that anomalous behavior is detected. For example, creation of excess accounts may indicate an attack on the enterprise attempting to gain unauthorized access, where creation of a less than typical number of identities may indicate that one or more systems of the enterprise may not be operating correctly.

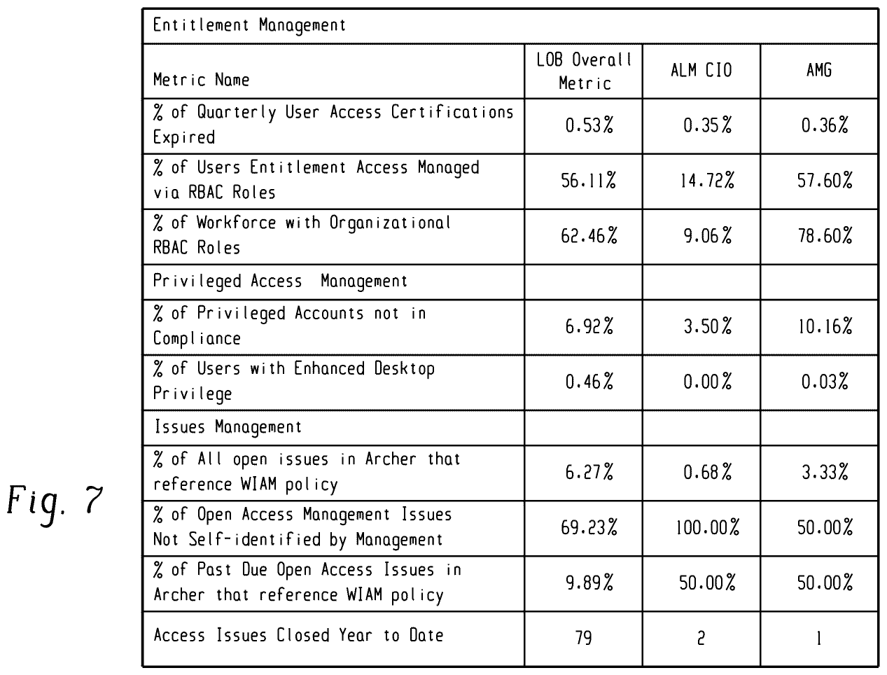

FIG. 7 illustrates an identity dashboard report. Having acquired information associated with identities for a plurality of resources of an enterprise, the engine computes metrics and reports on those metrics relative to certain thresholds. In the example of FIG. 7, values colored green indicate metrics that meet a “good” level threshold and values colored red indicate metrics that surpass a “needs attention” threshold. A first column indicates computed metrics for the entirety of the metric, where subsequent columns provide values for individual resources within the enterprise. Metrics calculated include: a percentage of quarterly user access certifications that expired, a percentage of users entitlement access that were managed via RBAC roles, a percentage of the workforce with organizational RBAC roles, a percentage of privileged accounts not in compliance with security protocols (<10% considered “good”), a percentage of users having enhanced desktop privilege, a percentage of all open issues that reference WIAM policy, a percentage of all issues not self-identified by management (>30% considered “needs attention”), a percentage of past due open access issues that reference WIAM policy (<10% considered “good,” >30% considered “needs attention”), and access issues closed to date.

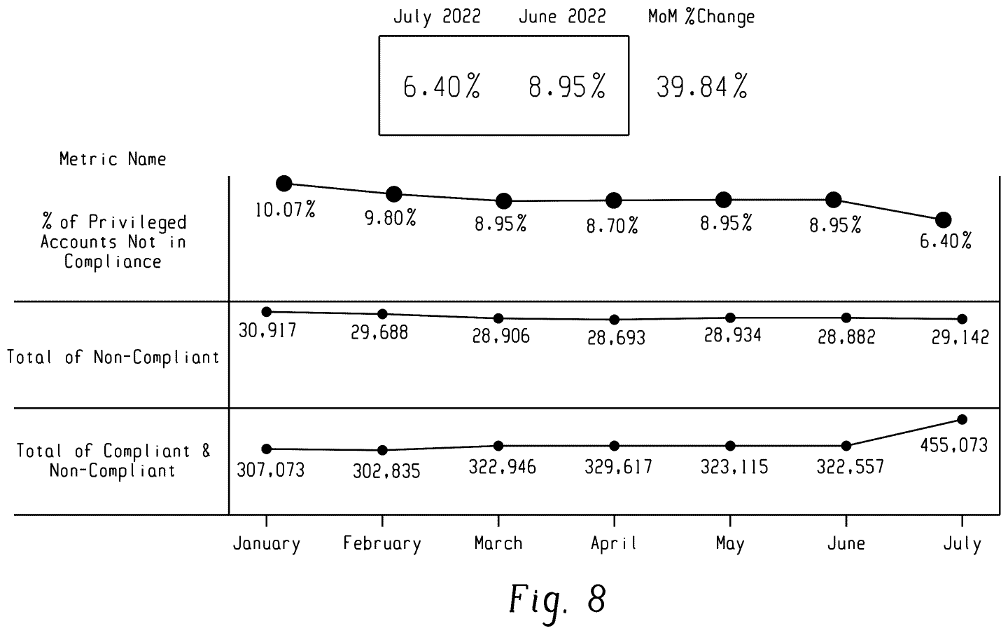

FIG. 8 is a diagram depicting trends for certain of the metrics calculated by the engine. In the example of FIG. 8, the percentage of accounts not in compliance with security policies is trending down in the first graph. The total number of non-compliant accounts is approximately flat, indicating that the downward trend in the first graph may be based on creation of new accounts rather than resolving compliance issues. A final graph confirms this, showing an increase of over 130,000 accounts in July.

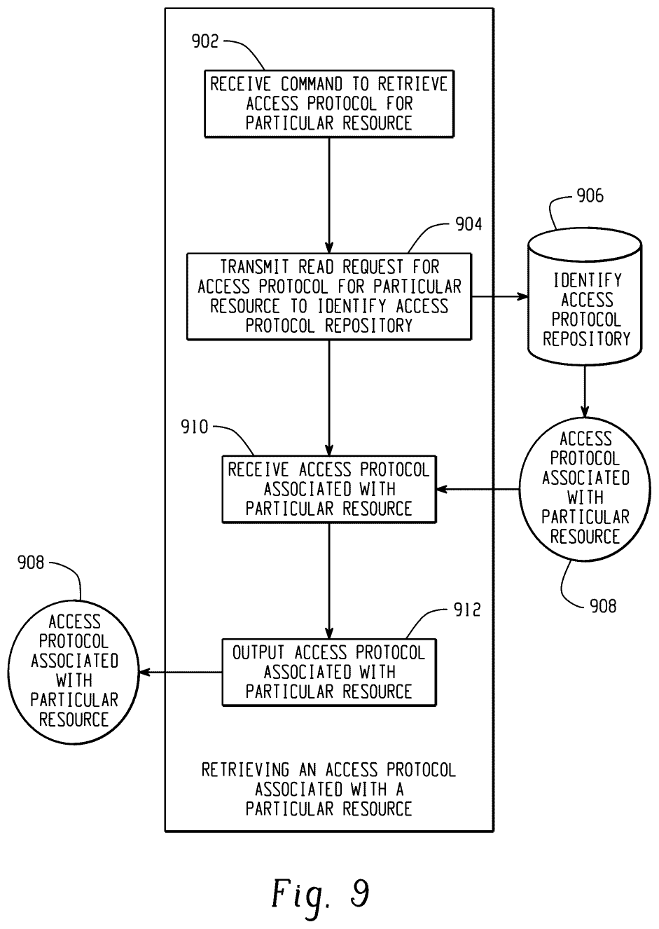

Operations performed by a centralized identity aggregation engine may take a variety of forms. FIG. 9 is a diagram depicting an example process for retrieving an access protocol associated with a particular resource. At 902, a command is received from the engine to retrieve an access protocol for a particular resource. At 904, a read request is transmitted from the engine to an identity access protocol repository 906 to retrieve an access protocol 908 for a particular resource. At 910, the access protocol associated with the particular resource is received, and at 912 the access protocol 908 associated with the particular resources is returned to the engine.

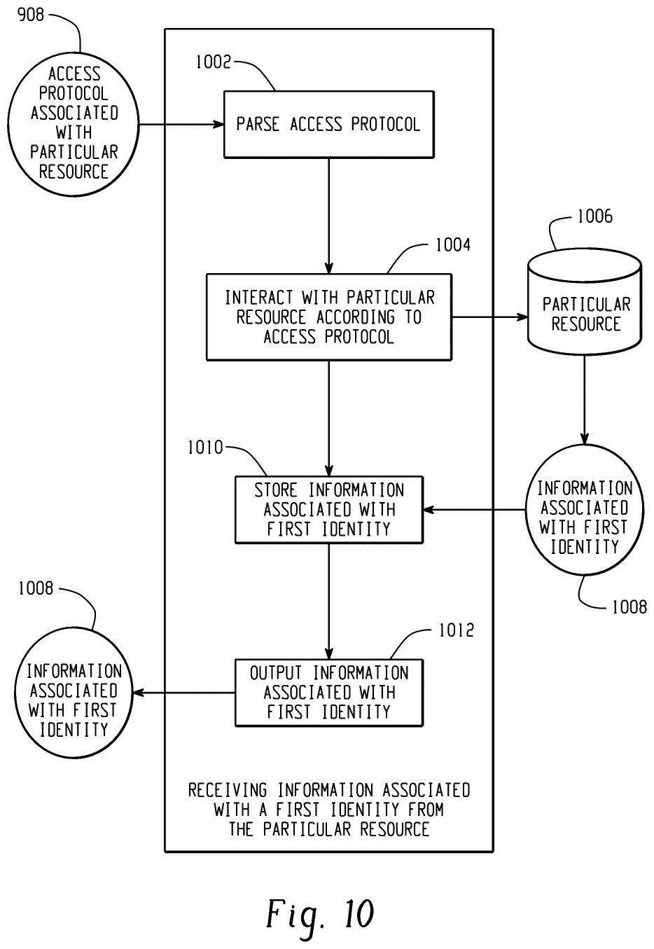

FIG. 10 is a diagram depicting an example process for retrieving information associated with a first identity from the particular resource. An access protocol 908 associated with a particular resource (e.g., the access protocol 908 of FIG. 9) is received and parsed at 1002. That parsed access protocol 908 is used at 1004 to interact with the particular resource 1006 (e.g., initiating a pull operation as indicated in the protocol 908, communicating with an API whose address is indicated in the protocol, executing software code in the protocol 908 to interact with the particular resource). Based on that interaction, the particular resource 1006 returns information associated with a first identity at 1008. That information associated with the first identity is stored at 1010 and output to the engine at 1012.

FIG. 11 is a diagram depicting an example process for determining whether a first identity is a privileged identity. Information associated with a first identity to be analyzed (e.g., information 1008 of FIG. 10) an a definition of privileged access for the particular resource (e.g., criteria or an analysis model such as an AI model) from the entity data store 308 of FIG. 3) are received at 1102. The information associated with the first identity 1008 is analyzed at 1104 in view of the privilege access definition to determine whether that first identity is privileged. At 1106 an indication of whether the first identity is privileged 1108 is output.

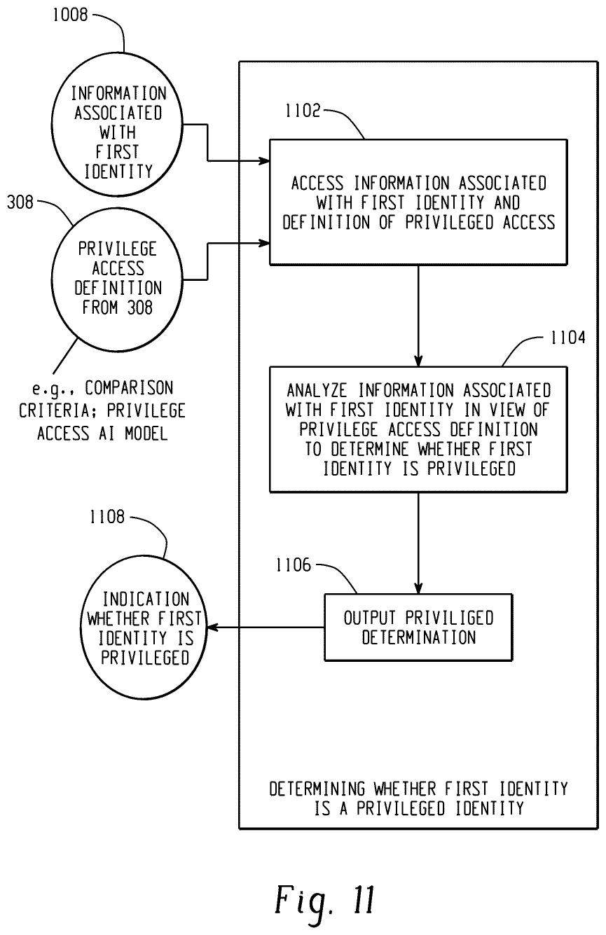

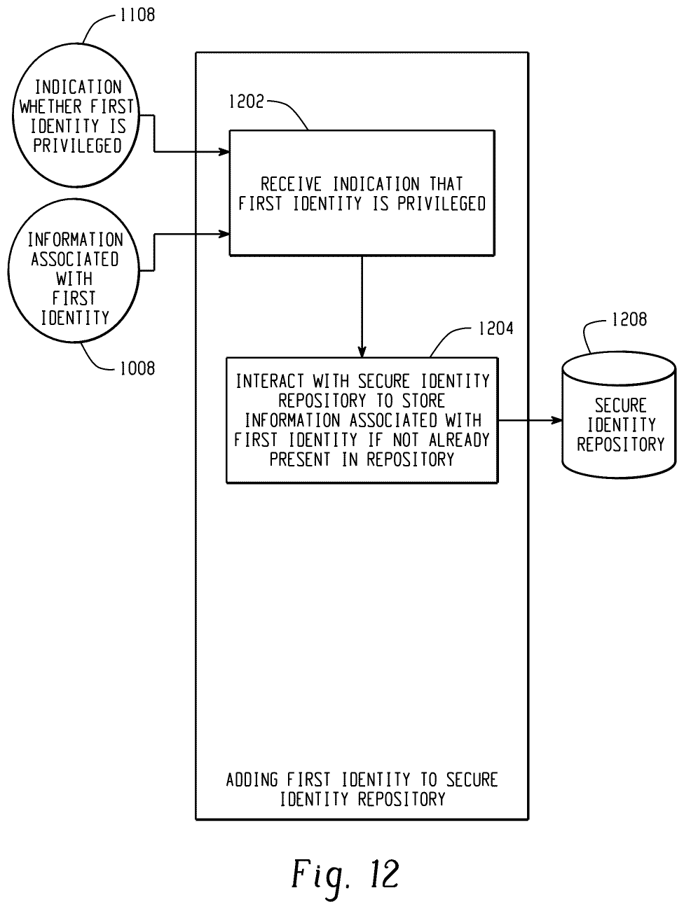

FIG. 12 is a diagram depicting an example process for adding the first identity to a secure identity repository. At 1202, an indication of whether the first identity is privileged (e.g., indication 1108 from FIG. 11) is received as well as information associated with the first identity (e.g., information 1008 of FIG. 10). At 1204, a system interacts with a secure identity repository 1206 to store information associated with the first identity is not already present in the repository. In some embodiments, if the first identity is already present in the repository, the system may update the information associated with the first identity if differences are present.

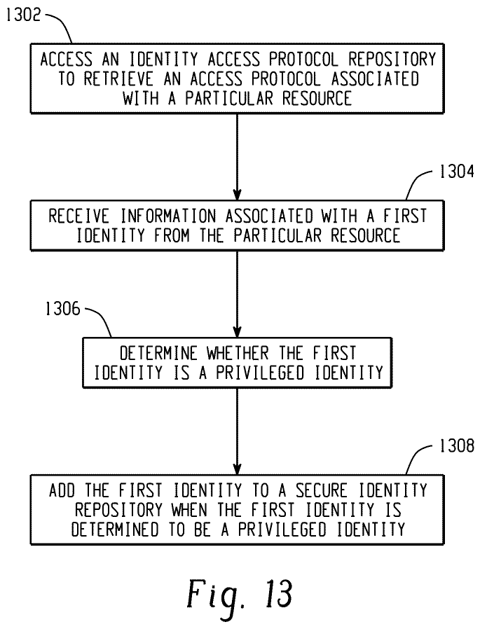

FIG. 13 is a flow diagram depicting a method of preventing unauthorized access to a computing system. An identity access protocol repository is accessed at 1302 to retrieve an access protocol associated with a particular resource. At 1304, information associated with a first identity is received from the particular resource based on access protocol associated with the particular resource. A determination is made at 1306 regarding whether the first identity is a privileged identity based on the received information associated with the first identity, and at 1308, the first identity is added to a secure identity repository when the first identity is determined to be a privileged identity.

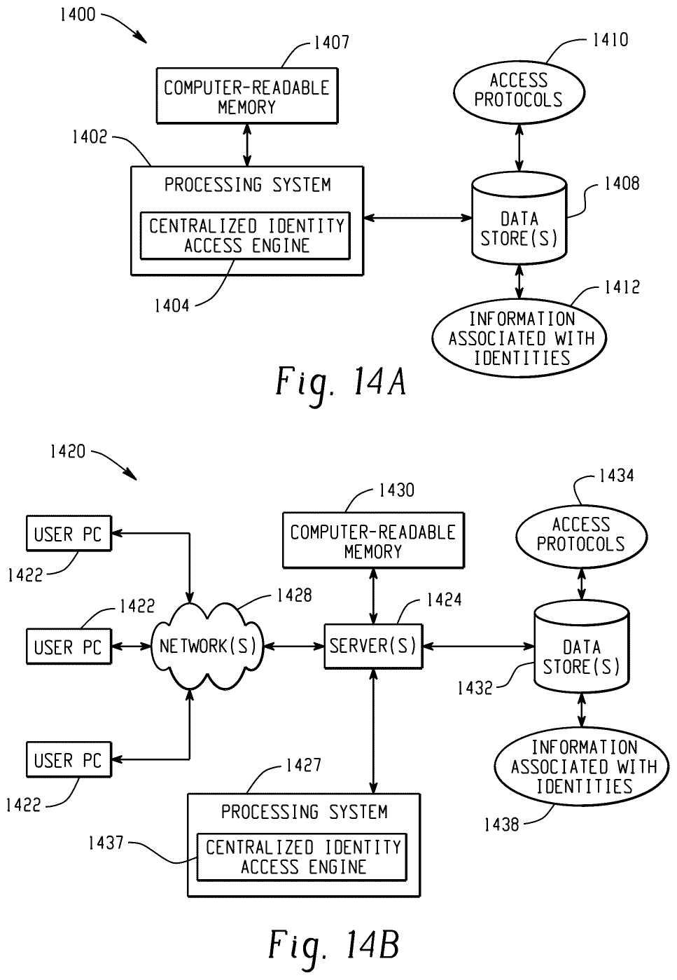

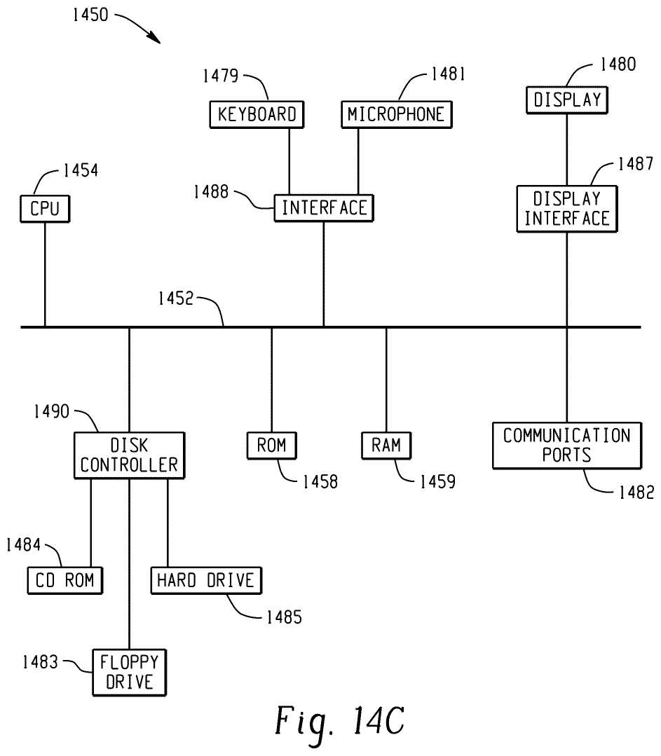

FIGS. 14A, 14B, and 14C depict example systems for implementing the approaches described herein for implementing centralized identity access engine. For example, FIG. 14A depicts an exemplary system 1400 that includes a standalone computer architecture where a processing system 1402 (e.g., one or more computer processors located in a given computer or in multiple computers that may be separate and distinct from one another) includes a computer-implemented central engine 1404 being executed on the processing system 1402. The processing system 1402 has access to a computer-readable memory 1407 in addition to one or more data stores 1408. The one or more data stores 1408 may include access protocols 1410 as well as information associated with identities 1412. The processing system 1402 may be a distributed parallel computing environment, which may be used to handle very large-scale data sets.

FIG. 14B depicts a system 1420 that includes a client-server architecture. One or more user PCs 1422 access one or more servers 1424 that include centralized identity access engine 1437 operating on a processing system 1427 via one or more networks 1428. The one or more servers 1424 may access a computer-readable memory 1430 as well as one or more data stores 1432. The one or more data stores 1432 may include access protocols 1434 as well as information associated with identities 1438.

FIG. 14C shows a block diagram of exemplary hardware for a standalone computer architecture 1450, such as the architecture depicted in FIG. 14A that may be used to include and/or implement the program instructions of system embodiments of the present disclosure. A bus 1452 may serve as the information highway interconnecting the other illustrated components of the hardware. A processing system 1454 labeled CPU (central processing unit) (e.g., one or more computer processors at a given computer or at multiple computers), may perform calculations and logic operations required to execute a program. A non-transitory processor-readable storage medium, such as read only memory (ROM) 1458 and random access memory (RAM) 1459, may be in communication with the processing system 1454 and may include one or more programming instructions for preventing unauthorized access to a computing system. Optionally, program instructions may be stored on a non-transitory computer-readable storage medium such as a magnetic disk, optical disk, recordable memory device, flash memory, or other physical storage medium.

In FIGS. 14A, 14B, and 14C, computer readable memories 1407, 1430, 1458, 1459 or data stores 1408, 1432, 1483, 1484, 1488 may include one or more data structures for storing and associating various data used in the example systems. For example, a data structure stored in any of the aforementioned locations may be used to store data from XML files, initial parameters, and/or data for other variables described herein. A disk controller 1490 interfaces one or more optional disk drives to the system bus 1452. These disk drives may be external or internal floppy disk drives such as 1483, external or internal CD-ROM, CD-R, CD-RW or DVD drives such as 1484, or external or internal hard drives 1485. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1490, the ROM 1458 and/or the RAM 1459. The processor 1454 may access one or more components as required.

A display interface 1487 may permit information from the bus 1452 to be displayed on a display 1480 in audio, graphic, or alphanumeric format. Communication with external devices may optionally occur using various communication ports 1482.

In addition to these computer-type components, the hardware may also include data input devices, such as a keyboard 1479, or other input device 1481, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

It is claimed:

1. A method of preventing unauthorized access to a computing system, comprising:
accessing an identity access protocol repository to retrieve an access protocol associated with a particular resource;
receiving information associated with a first identity from the particular resource based on the access protocol associated with the particular resource;
determining whether the first identity is a privileged identity based on the received information associated with the first identity;
adding the first identity to a secure identity repository when the first identity is determined to be a privileged identity.

2. The method of claim 1, wherein the access protocol associated with the particular resource includes an address for transmitting a request of identity information to the particular resource.

3. The method of claim 1, wherein the access protocol associated with the particular resource comprises software instructions for retrieving identity information from the particular resource.

4. The method of claim 1, wherein the access protocol associated with the particular resource indicates that identity information is received from the particular resource via a push protocol.

5. The method of claim 1, wherein the secure identity repository is configured to provide credential information associated with the first identity to an authorized requester.

6. The method of claim 5, wherein the authorized requester is a second resource, wherein the second resource is configured to use the credential information associated with the first identity to access the particular resource.

7. The method of claim 6, wherein the second resource accesses the particular resource without intervention by a human operator.

8. The method of claim 1, further comprising:
determining whether the first identity is anomalous.

9. The method of claim 8, wherein, when the first identity is determined to be anomalous:
access by the first identity to the particular resource is disabled; and
an alert communication is issued.

10. The method of claim 8, wherein the first identity is determined to be anomalous based on a comparison of the information associated with the first identity matches one or more anomalous access criteria.

11. The method of claim 8, wherein the first identity is determined to be anomalous by providing the information associated with the first identity to a model trained on information associated with a plurality of anomalous identities and a plurality of permissible identities.

12. The method of claim 8, wherein the determination of whether the first identity is anomalous is based on the first identity having been determined to be a privileged identity.

13. The method of claim 1, wherein the first identity is determined to be a privileged identity based on comparison of the information associated with the first identity to one or more privileged access criteria.

14. The method of claim 1, wherein the one or more privileged access criteria are associated with the particular resource.

15. The method of claim 1, wherein said accessing, receiving, determining, and adding are repeated for a plurality of additional resources that are different than the particular resource.

16. the method of claim 15, wherein the access protocol associated with the particular resource comprises an API address and protocol for requesting information associated with identities that are authorized to access the particular resource;
wherein an access protocol associated with a second resource indicates that information associated with identities that are authorized to access the second resource can be accessed via a pull operation; and
wherein an access protocol associated with a third resource indicates that information associated with identities that are authorized to access the third resource can be accessed via a push operation;

17. The method of claim 15, further comprising determining whether a second identity that is present in the secure identity repository is not received from the particular resource.

18. The method of claim 1, wherein the particular resource is a data store, a database, the secure identity repository, a particular record in a data store, a server, a service operating on a server, an operating system, an enterprise manager, an active directory, a network automation engine, network attached storage, an identity management store, a mainframe, an application, a cloud environment, a service associated with a cloud environment, a computer, a phone, or a mobile communication device.

19. The method of claim 1, further comprising transmitting a report indicating a number of new identities associated with the particular resource and other resources during a pre-determined time period.

20. A system for preventing unauthorized access to a computing system, comprising:
an identity access protocol repository configured to contain access protocols associated with a plurality of resources;
an identity access engine configured to access the identity access protocol repository to retrieve an access protocol associated with a particular resource and to receive information associated with a first identity associated with the particular resource from the particular resource based on the access protocol;
an entity data store configured to retain data for use by the identity access engine to determine whether the first identity from the particular resource is a privileged identity; and
a secure identity repository for storing data associated with the first identity when the first identity is determined to be a privileged identity.

21. The system of claim 1, further comprising a plurality of identity controlled resources that include the particular resource.

22. A system for preventing unauthorized access to a computing system, comprising:
means for accessing an identity access protocol repository to retrieve an access protocol associated with a particular resource;
means for receiving information associated with a first identity from the particular resource based on access protocol associated with the particular resource;
means for determining whether the first identity is a privileged identity based on the received information associated with the first identity;
means for adding the first identity to a secure identity repository when the first identity is determined to be a privileged identity.
